(19) United States
(12) Patent Application Publication
(10) Pub. No.: US 2005/0224094 A1
(43) Pub. Date: Oct. 13, 2005

(54) Apparatus and methods for isolating bioreactive materials on a microarray substrate surface

(76) Inventor: Randall W. Davis, Pleasanton, CA (US)

Correspondence Address: CHARLES LOUIS THOEMING, 1390 WILLOW PASS ROAD, SUITE 1020, CONCORD, CA, 94520, US

(21) Appl. No.: 10/814,810

(22) Filed: Mar. 31, 2004

(51) Int. Cl. B08B 13/00

(52) U.S. Cl. 134/2

(57) ABSTRACT

Apparatus and methods of isolating functionalizing reagents and unreacted bioreactive material in an array of microscopic sense site wells in a substrate surface and to scrub clean the sense site substrate surface. The disclosed apparatus and methods improve systems for detecting biochemical reactions to any of a variety of microarray probe materials by a variety of techniques including, but not limited to, electrical, fluorescent, calorimetric, or enzymatic detection.

### CROSS-REFERENCES TO RELATED APPLICATIONS

None.

### STATEMENT REGARDING FEDERALLY SPONSORED RESEARCH OR DEVELOPMENT

None.

### REFERENCE TO A MICRO-FICHE APPENDIX

None.

### BACKGROUND OF THE INVENTION

1. Field of the Invention

This invention relates to apparatus and methods of isolating bioreactive materials on a microarray substrate surface. The bioreactive material can be any of a number of substances including, but not limited to, L-lysine, amino-silane, epoxy-silane, epoxy, polymers, carboxy-silane, DNA, cDNA, RNA, aRNA, oligonucleotide strands, proteins, ligands, antibodies, and the like.

Today's microarrays use fixed spots of DNA, cDNA, oligonucleotides, proteins, ligands, or antibodies as the reaction site or capture site to detect the presence of biogenic substances in test solutions. To deposit such a capture molecule or spot, a two-step process is often applied as follows:
1) the substrate surface is made reactive or functionalized to capture and hold a probe molecule by applying a substance to the entire surface of the microarray; and
2) all of the techniques used to deposit a spot of material on the microarray, including contact spotting, piezoelectric, ink-jet, and photolithographic methods, place one spot of a unique capture molecule on a specific location on the microarray surface whereby the functionalizing material remains between the deposited spots.

All microarrays constructed today are finished creating the probe spots when the spot is deposited onto the array.

The methods of the present invention allow one spot deposition to be further separated into multiple distinct, isolated spots. If a functionalizing reagent was used on the array surface, it is also removed from between the spots. Thus, for example, a single 80 micron diameter spot deposited onto the surface by the apparatus and methods of the present invention will be separated into 70 to 80 five micron square spots of identical material.

The more replicates of one specific probe material that can be placed on a microarray, the greater the confidence levels that result from the analysis of hybridization events. Currently to produce meaningful high-confidence data, multiple spots of the identical, or slightly mismatched, probe or capture material are deposited on a microarray substrate. The present invention allows only one spot to be deposited onto the array and then the original deposited spot is subsequently divided into multiple spots. In this fashion, the area required on an array to make multiple spots is reduced. This method of isolating both the surface functionalizing coating (1) and the unique capture probe or spot (2) is also a basic requirement for detecting hybridization events on microarrays at closely spaced probe spots using electrical detection means.

The use of photolithographic techniques to create microscopic wells or depressions in envisioned and thus extremely small well sizes can be manufactured. The well size and the subsequent size of isolated spots resulting from a single probe deposition are limited only by the resolution of semiconductor photolithographic techniques.

The apparatus and methods of the present invention describe the isolation of DNA from one spot deposition into multiple wells or sense site wells. The apparatus and method could just as readily be constructed with other nucleic acids, proteins, ligands, antibodies, or other biomolecules that can bind specifically to counterparts in solution. In the DNA example, the DNA probes serve to bind or hybridize with their antisense strands of DNA in a sample solution. The hybridization and therefore presence of similar DNA strands in the sample can be detected in the sense wells using conventional fluorescent, calorimetric, or enzymatic methods known in the art. This isolation method also allows the hybridization event to be detected by measuring changes in the resistance to electrical current, capacitance, or inductance across the sense site or wells.

2. Description of the Related Art

A search of the prior art located the following United States patents which are believed to be representative of the present state of the prior art: U.S. Pat. No. 6,333,200 B1, issued Dec. 25, 2001; U.S. Pat. No. 6,355,491 B1, issued Mar. 12, 2002; and U.S. Patent Publication No. U.S. 2002/0164819 A1, published Nov. 7, 2002.

U.S. Pat. No. 6,333,200 B1 issued Dec. 25, 2001, provides a solution for getting probe substances located solely in the sense site gaps. Probe molecules first are affixed to latex coated magnetic particles. The particles are then attracted to bind in the gap of a particular sense site by applying an alternating voltage to individual pairs of conductive traces. The resulting dielectrophoretic force accumulates the probe-coated magnetic beads into the sense site gap. The present invention does not use this time intensive method to place material into sense sites one at a time. In addition, the U.S. Pat. No. 6,333,200 patent does not address isolating the unreacted functionalizing coating material that remains on the substrate between the spots or sense site wells.

Electrical sensing techniques using inductance or magnetism to sort reactants, attract reactants to specific locations, or sense hybridization have been defined. Patent Publication No. U.S. 2002/0164819 A1, published Nov. 7, 2002, shows an inductive site shaped as a bucket that attracts magnetic particles coated with biomolecules. In addition, the sense site can be energized to attract a large magnetic bead added to the target solution that will cover or act as a lid on the sense site bucket. To energize the magnetic bucket described, a DC current must be applied to each site, one site at a time. This requirement makes simple, dense construction of probe spots or sense sites extremely time consuming and practically impossible. The connection layout to sense sites prescribed in this patent publication is line intensive and does not lend itself to dense sense site construction. By contrast, FIGS. 13 and 14 from U.S. Pat. No. 6,355,491 B1, issued Mar. 12, 2002, to Zhou, et al., defines an inductive element produced in silicon that is used to attract (or repel) biomolecules from individual locations thus speeding up the reactions that might otherwise be dependent on slower passive diffusion. It does not define how to isolate the probe spots or probe sense sites from one another. The complex nature of individually addressing inductive sites is illustrated in present invention and is presented to show the difficulty in isolating thousands of unique spot reagents to individual sites on a single substrate.

### DETAILED DESCRIPTION OF RELATED ART

A bioreactive, functionalizing, layer often must first be laid down on a substrate to which the first of two substances that hybridize can be affixed. The current methodologies for applying a bioreactive layer affix the material over the entire surface of the microarray substrate or sense chip. This procedure leaves material between spots and between sense sites which links the sites and can influence electrical or fluorescent readings. The art does not teach how to remove functionalizing coatings from microarray surfaces, nor does it teach how to isolate bioreadtive material into a single microscopic site. One is left with no alternative but to microscopically apply functionalizing liquid and probe material individually to each site. This is not feasible.

The use of metal-coated slides as the microarray substrate eliminates the need for applying a functionalizing layer on the substrate. The problem of how to take one spot of probe material and separate in into multiple microscopic spots, however, still remains.

In summary, the prior art does not define how to produce microscopic sense sites that contain a minute amount of any of a variety of functionalizing substances used for probe attachment and separated from neighboring sense sites, nor does the art teach how to produce independent microscopic sense sites that have a probe substance (the first of two substances that will hybridize to each other) deposited in a multitude of neighboring sense sites from one probe spot deposition.

### BRIEF SUMMARY OF THE INVENTION

The present invention provides apparatus and methods to isolate functionalizing coatings and bioreactive material within multiple sense site wells.

Microscopic magnetic beads or magnetic beads coated with various substances have historically been used to mix reagents by moving the beads in solution by applying an external magnetic field. Alternatively, beads have been coated with specific DNA segments, specific antigens or antibodies, or specific proteins or ligands, and added to unknown solutions to bind to a second molecule and then be pulled out of solution—thereby isolating or removing the bound second molecule from the unknown solution.

The present invention is neither a stirring or mixing function. Nor does the present invention isolate a known molecule from solution. The present invention uses a magnetic, metallic, charged, glass, silane coated, epxoy coated, or inert beads to scrape or clean a surface and remove all molecules that might otherwise be bound to the surface leaving the surface clean with no attached particles. This process is particularly useful for isolating reagents into independent, microscopic depressions or wells on a substrate surface. The usefulness of the technique of the present invention is not limited to isolating substances in a sense site or well. It can be useful for quick cleaning of any hard substrate. The substrate can be a planar material or three dimensional. In one embodiment of the present invention, the beads are magnetically pulled down onto the substrate surface, and then moved via external magnetic or electro-magnetic energy to scrub the surface. In another embodiment of the present invention, microscopic inert beads are suspended in solution and then vortexed to be moved at high speed. The microarray substrate is placed in the agitated or vortexed solution and the beads scrape away reagents from the substrate array surface, leaving reagent behind in the well depressions.

If the substrate is an electrical sense chip as described in U.S. non-provisional patent application Ser. No. 10/681,630, filed Oct. 8, 2003, the surface is coated with a passivation layer everywhere except over the sense-site wells. This passivation layer serves to make the top surface of the chip as planar as possible to withstand the stress of contact printing of samples. The combination of etched wells in substrate isolation layers, and the passivation layer contribute to produce wells or sense sites. These wells, together with the bead mop method of the present invention as detailed herein, serve to separate the functionalized coating and probe material into many independent sites for potential hybridization. This separation step, in turn, is a critical feature of the present invention which provides means for multiple readings of a single application of a probe spot to a sense chip array surface, and thus providing statistically meaningful analysis of hybridization events.

Other features, advantages, and objects of the present invention will become apparent with reference to the following description and accompanying drawings.

### BRIEF DESCRIPTION OF DRAWINGS

These and other objects, advantages and novel features of the invention will be more readily appreciated from the following detailed description when read in conjunction with the following drawings, in which:

FIG. 1 presents an example of the operation of a magnetic or metallic bead in cleaning sense chip surface-bead mop of an embodiment of the present invention.

FIG. 2 presents an example of bioreactive functionalizing agent applied to the entire array surface of an embodiment of the present invention.

FIG. 3 presents an example of the bioreactive functionalizing agent from FIG. 2 remaining in sense site wells and removed from non-sense site surface after bead mop of an embodiment of the present invention.

FIG. 4 depicts a probe spot applied to a sense chip of an embodiment of the present invention.

FIG. 5 depicts a probe spot and blocking solution applied to a sense chip of an embodiment of the present invention.

FIG. 6 depicts a probe spot and blocking solution applied to a sense chip of FIG. 5 after rinsing/bead mop of the array for an embodiment of the present invention.

FIG. 7 depicts a side view of a probe bound to sense site of the array after isolation provided by the apparatus and methods of the present invention.

FIG. 8 depicts a side view of a microarray substrate submerged in solution containing beads within in a vortexer chamber.

FIG. 9 depicts a side view of a microarray substrate submerged in solution containing beads within in a chamber comprising magnetic mixing means.

FIG. 10a depicts a front view of a microarray substrate submerged in solution containing beads.

FIG. 10b depicts a side view of a microarray substrate submerged in solution containing metallic beads within a chamber comprising magnetic mixing means.

FIG. 11 depicts a side view of a solution containing beads and means to spray the microarray with the liquid-bead mixture.

FIG. 12 depicts a side view of an air/gas pressure system in which beads are fed into pressurized air/gas stream prior to exiting from the nozzle wherein the beads strike and clean the microarray surface.

FIG. 13 depicts a side view of an air/gas agitator chamber filled with lightweight beads that are blown or otherwise forcibly dispersed within the chamber wherein the beads strike and clean the exposed microarray surface attached to the chamber interior.

For simplicity in description, identical components are identified with the same numerals in this application.

### DETAILED DESCRIPTION OF THE INVENTION

The present invention is useful in isolating bioreactive substances in depressions or wells in the sense chip substrate or to scrub clean the sense chip substrate after probe spotting has been applied to the sense chip surface and array of sense sites thereon.

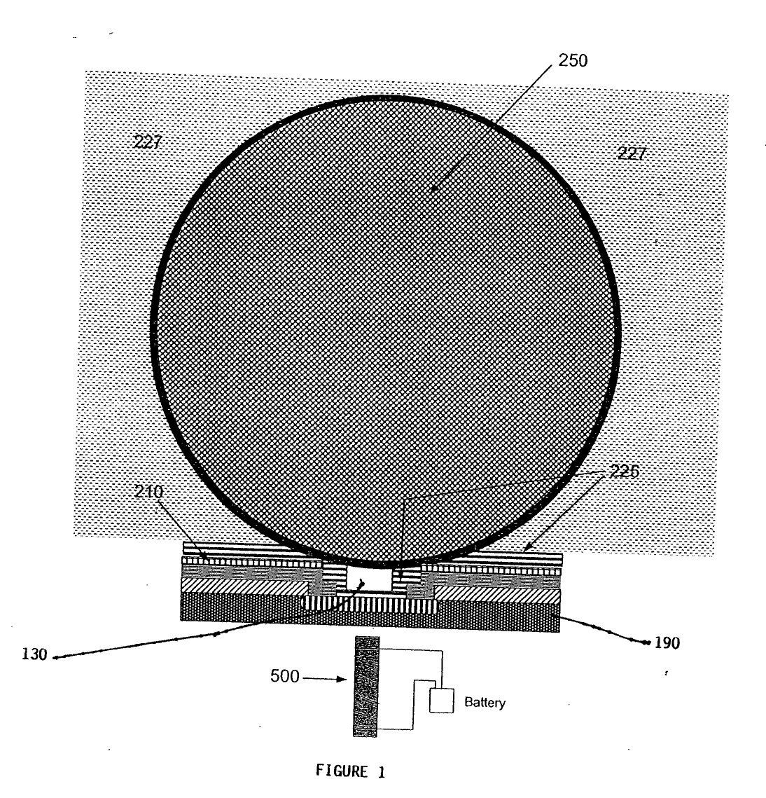

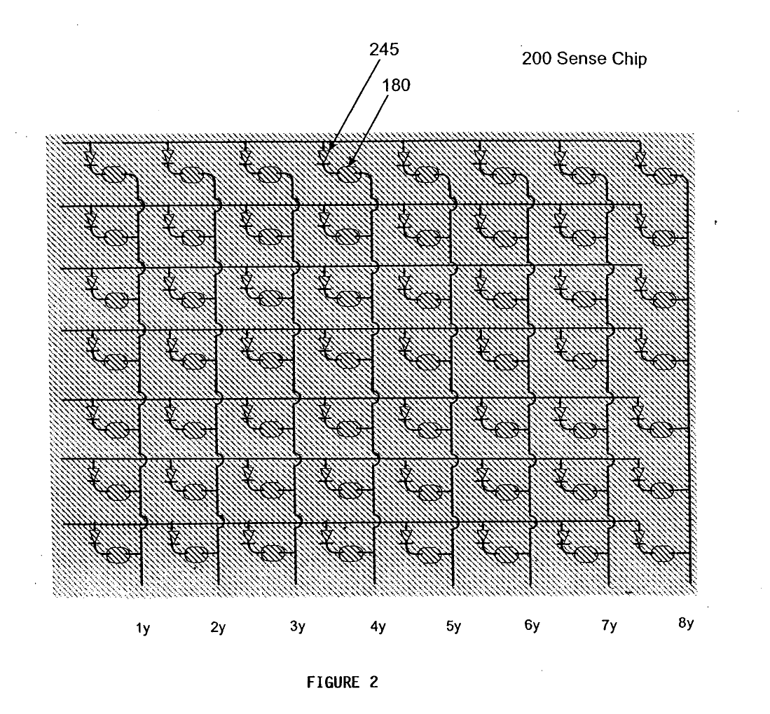

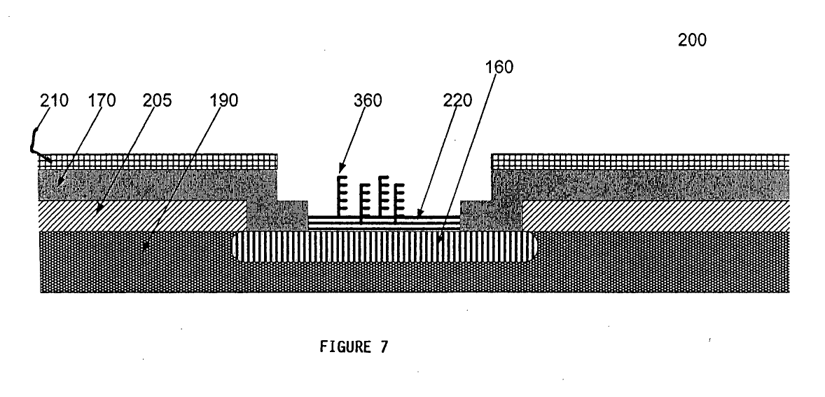

The construction method and materials described in the inventor's pending U.S. non-provisional patent application Ser. No. 10/681,630, result in a well surrounding the sense gap substrate. As described therein and earlier in this application, the substrate is generally planar, having a top side. The substrate top side further comprises one or more sense sites wherein each sense site comprises a well to receive probe molecules. A matrix or array of sense sites is defined by a plurality of sense sites on the planar substrate top side. Depositing a bioreactive substance or probe substance only in the microscopic well and not on the surrounding surface of the sense chip 200 is a challenge, FIGS. 2 and 7. The present invention utilizes a bead element 250, as shown in FIG. 1, coated with latex, or latex and a layer of substance which binds strongly to both the latex and the bioreactive reagent 225 that is on the sense chip surface, or no latex but a layer of substance that binds directly to the magnetic, metallic, glass, or resin bead and bioreactive reagent on the surface of the chip or simply a charged bead of any material or a plain metallic, magnetic, glass, or resin bead. The bead element 250 composition may comprise metal, coated metal, magnetic material, coated magnetic material, positively charged agarose material, negatively charged agarose material, coated positively charged agarose material, coated negatively charged agarose material, positively charged latex material, negatively charged latex material, coated positively charged latex material, coated negatively charged latex material, glass, coated glass, resin, coated resin, ceramic, coated ceramic, plastic, negatively charged plastic, positively charged plastic, coated plastic, negatively charged coated plastic, or positively charged coated plastic as are readily available from commercial manufacturers. Bead size is limited only by the technology required to produce them and varies from 1.4 nano-meters to thousands of microns in diameter. The bead diameter should be selected so that beads are sufficiently large to prevent them from entering or dropping down into the sense site wells of the sense chip substrate. For a sense site well depth of 4 microns and a sense site well diameter of 10 microns, bead diameter should be at least eight times the well diameter, or a bead diameter of 80 microns. Preferred embodiments of the present invention with varying sense site matrices or arrays use bead diameters ranging from 5 microns to 1000 microns. Bead diameters exceeding 1000 microns or less than 5 microns are applicable to the method and apparatus of the present invention.

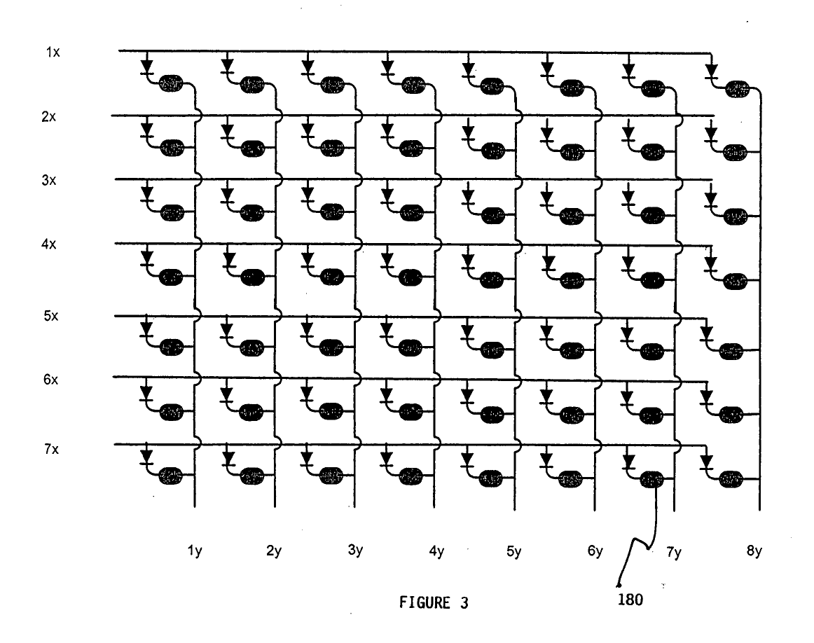

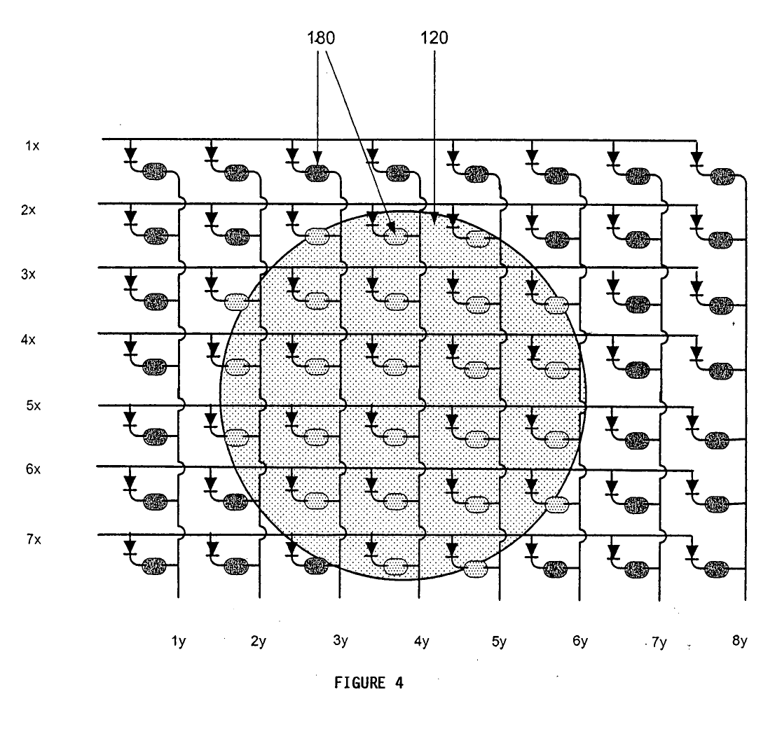

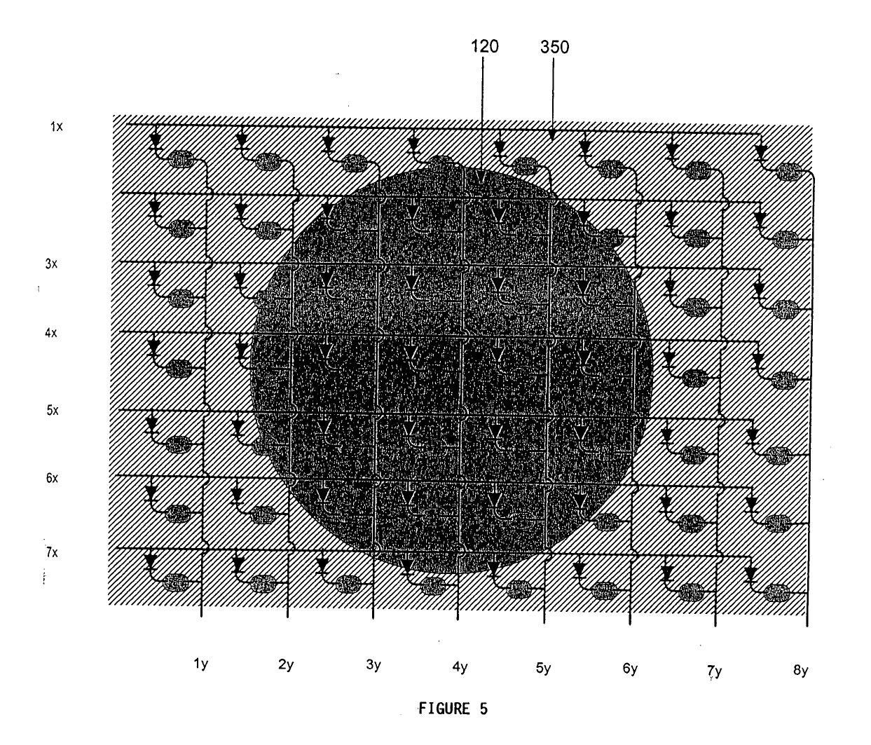

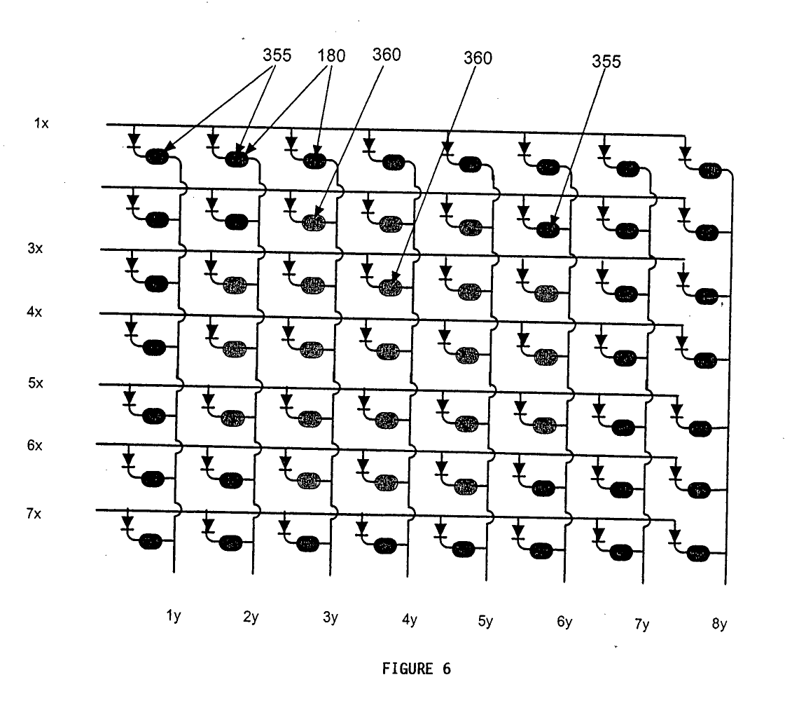

The beads 250 are added to an inert solution and the bead solution 227 is then placed over the surface of the sense chip 200, as depicted in FIG. 2, covering a plurality of sense sites 180. In an embodiment of the present invention, permanent magnet(s) and/or electromagnet(s) 500 are positioned beneath the sense chip substrate and attract the beads 250 from solution down to the surface of the sense chip, as depicted in FIG. 1. Movement of the substrate 190, external permanent magnets, or electromagnets, or varying an external magnetic field by randomly or sequentially energizing single or multiple electromagnets underneath or around the substrate will result in physically moving and rolling the beads around the surface or passivation layer 210 of the sense chip 200. As a result, the surface of the beads 250 will contact, strike, bind, and/or remove or physically break away the bioreactive reagent 225 present on the surface or passivation layer 210 of the chip 200 but not the material present in the sense gap 130 depressions or wells. After an appropriate period of time, the mopping of the sense chip surface with the beads is complete and the magnetic field is removed. The solution is then rinsed away. This leaves a sense chip with a scrubbed passivation layer 210, and bioreactive layer 220 substance remaining only in all the sense site 180 wells and coating the exposed sense leads 170 and sense site gap substrates 190, as depicted in FIGS. 1, 3, and 7. Probe molecules with an affinity for the bioreactive layer 220 will be drawn to and bind to the surface of the sense site wells. This bead mop apparatus and method, FIGS. 1-7, result in an unreacted, functionalized layer coating of the researcher's choice, residing solely in the sense site wells, ready for further processing. It is envisioned that this step of functionalized coating would be performed by the manufacturer but could be performed on completely blank sense chips by the user.

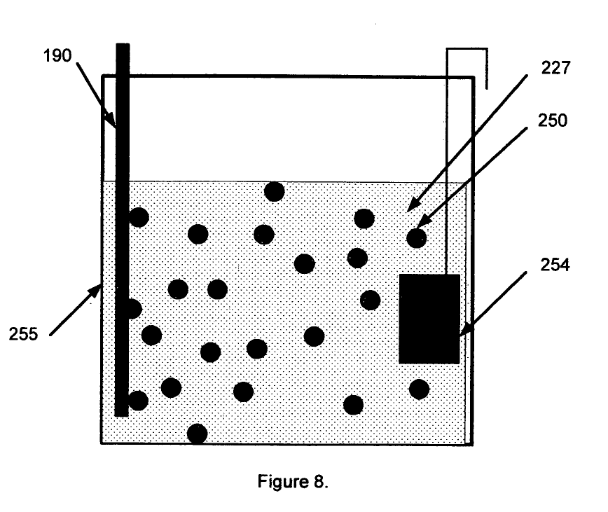

In another embodiment of the present invention, as depicted in FIG. 8, silanized glass beads, glass beads, plastic beads, or metal beads 250 are placed in solution 227 within a vortex chamber 255 and vortexed using a vortexer means 254 so that the beads 250 are spinning in an inert solution. The microarray substrate 190 is dipped into this agitated inert solution 227 and the beads 250 communicate with the substrate 190 surface, dislodging or scraping away functionalizing reagent, probe material, or both from the non-well surface of the microarray.

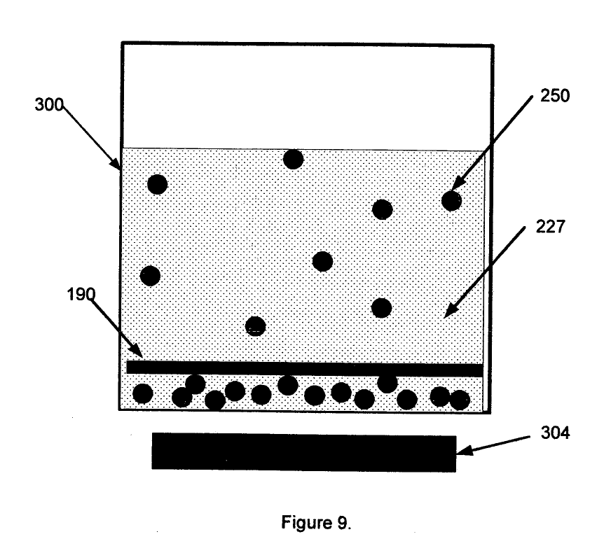

In yet another embodiment of the present invention, as depicted in FIG. 9, metal and other beads 250 as specified herein are placed in a shallow solution 227 within a magnetic stirring chamber 300 comprising magnetic stirring means 304. The microarray substrate 190 is placed face down into the chamber 300 with the active-surface of the substrate in contact with the beads on the chamber bottom. The magnetic stirring means 304 is activated which circulates the beads 250 between the chamber bottom and the microarray surface, scraping away unwanted material in the process.

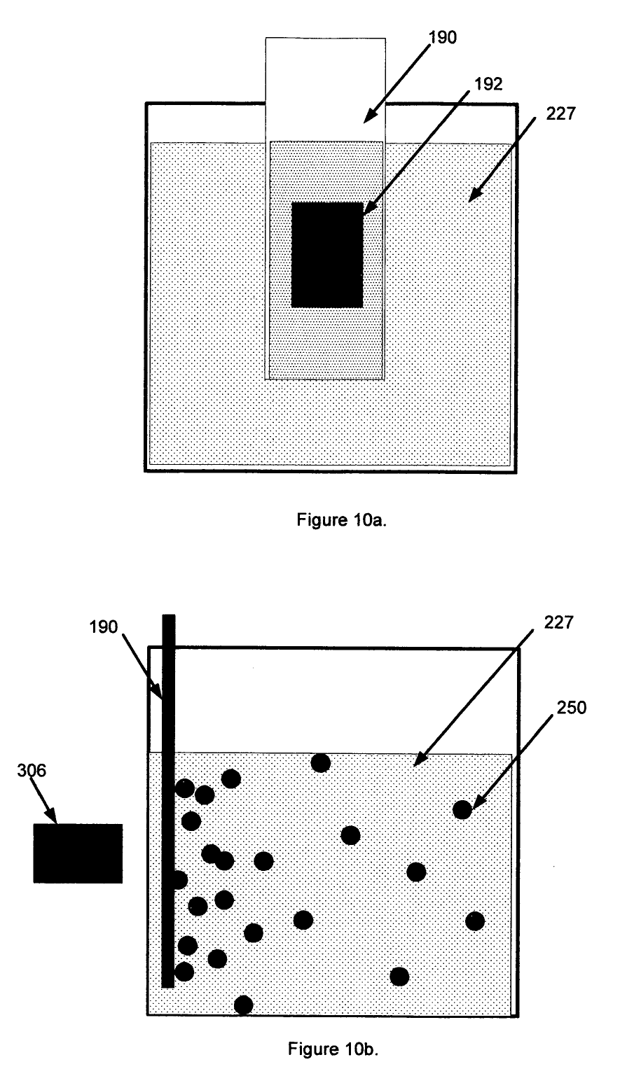

In still another embodiment of the present invention, as depicted in FIGS. 10a and 10b, metal beads 250 are placed in an inert solution 227. The microarray 192 is placed with its active surface facing into the solution 227 and the back of the substrate 190 towards the side of the chamber 300. A powerful magnetic or electromagnetic means 306 is positioned externally to the chamber 300 so that when the magnetic or electromagnetic means 306 is energized the magnetic beads 250 strike the surface of the microarray 192. The magnetic or electromagnetic means 306 is moved or alternately pulsed so that the beads 250 repeatedly contact and/or circulate upon the microarray 192 surface.

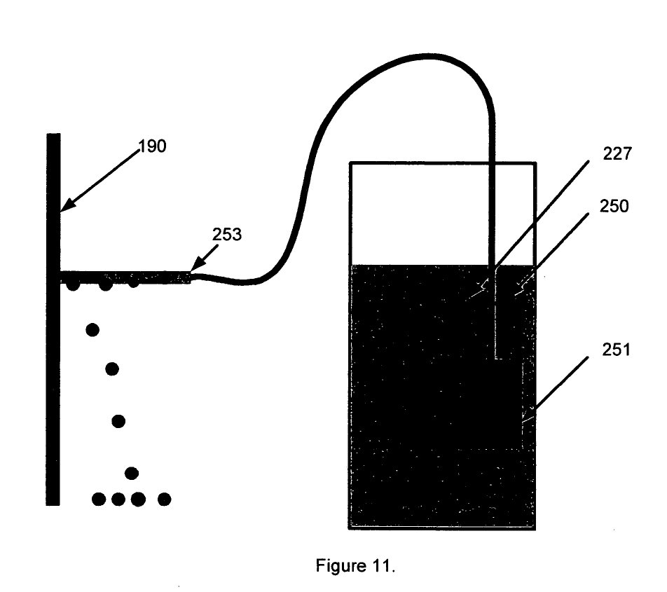

FIG. 11 depicts an embodiment of the present invention wherein the beads 250 are suspended in solution 227 and pumped through a nozzle 253 to strike the microarray surface 190 and wash away all material outside the sense site wells.

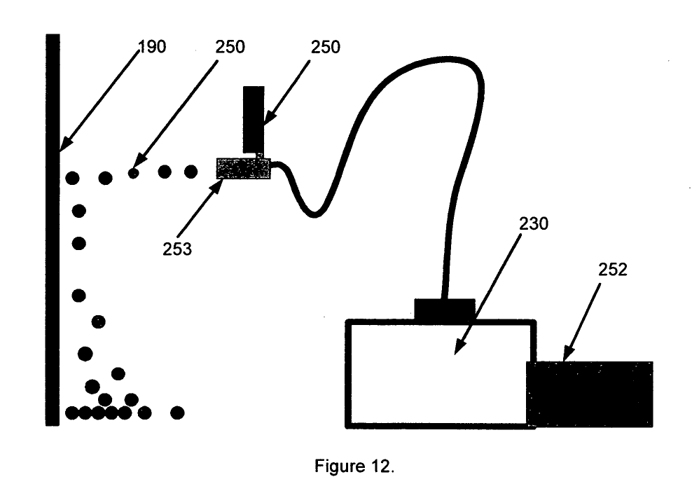

Similarly, as shown in FIG. 12, lightweight beads 250, such as plastic, can be fed through a small opening into a strong stream of air or inert gas driven by pressurized air or gas blower 252 and the resulting mixture 230 fed through a nozzle 253 to strike the microarray surface 190 and wash away all material outside the sense site wells.

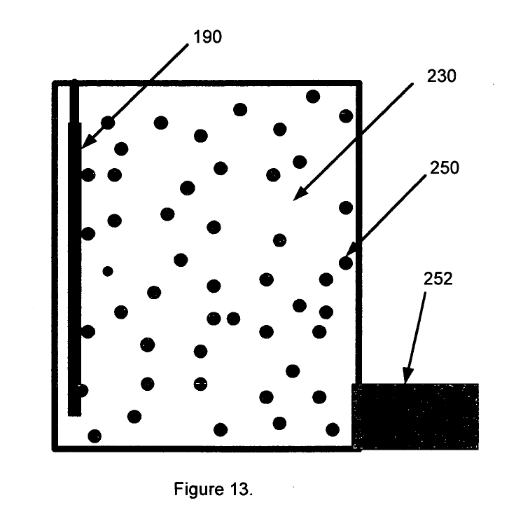

In another embodiment of the present invention, FIG. 13, lightweight beads 250 are placed into a closed vessel comprising air or an inert gas 230 and at least one microarray surface 190. The beads 250 and air or inert gas 230 are agitated within the closed vessel by a pressurized air or gas blower 252, wherein the beads repeatedly strike the microarray surface 190 and all biogenic substances are removed from all surfaces of the microarray except the interior of the wells.

The methods and apparatus of the present invention as depicted in FIGS. 8-13 and discussed herein provide a critical advantage in that material scraped or pulled from the microarray surface is allowed to fall away from the surface of the array and thus not rebind at other locations within the array.

### Example of Blocking and Fixing Stationary DNA to the Sense Chip and Cleansing the Sense Chip Substrate Surface using the Methods and Apparatus of the Present Invention

Sense Chip

1. An electrical sense chip containing thousands of microscopically isolated sense sites, each sense site having its sense gap covered with a bioreactive metal or metal oxide, or treated with a bioreactive layer of amino silane (or other substance such as epoxy silane known to bind to glass and DNA) is placed on a clean level surface.

2. When the probe spotting machine has been set up and just prior to the start of spotting, remove the clear plastic wrap from the top of the sense chip.

Preparation of Stationary Probe Spotting Solution and Spotting of Probe to Sense Chip

1. For each probe spot, place 2 μg of probe DNA at a concentration of 1 g/μl in a solution of dH₂O and 10% DMSO.

2. Heat DNA mixture to 95 degrees C. for 15 minutes and then place on ice.

3. Position probe DNA samples in appropriate container (864 well plate) and set into probe spotting machine.

4. Run machine and spot probe onto the sense chip.

5. Allow to air dry and store covered at room temperature.

Blocking and Fixing Stationary DNA to the Sense Chip

1. To a clean 1.5 ml tube add 25 μL of Master mix (0.1 g dextran sulfate, 5 mL formamide, and 1 ml 20×SSC and water up to 7 ml, pH 7.0) and enough fractionated Salmon Sperm DNA to reach a concentration of 250 μg/ml.

2. Heat the mixture to 37 degrees C. and quickly apply to the surface of the sense chip. Cover the sense chip cavity with the supplied plastic cover and place on a slow rocker platform in 37 degrees C. incubator for 30 minutes.

3. Rinse the sense chip twice with 2×SSC solution at 45 degrees C. for 5 minutes.

4. Let chip or substrate dry and place in a stratalinker. Apply 2600 μj×100 of energy to the substrate to link the probe molecules to the surface of the array.

5. In a separate glass container combine magnetic beads and glass beads with 2×SSC or histidine. Place the container on a magnetic stirrer and turn the magnetic stirrer on. Dip the microarray into the vortexed solution with the array active surface facing the vortex stream.

6. Remove the chip from the container and quickly rinse in 2×SSC at 45 degrees C. for 2 minutes.

7. Rinse the chip for 2 minutes in 0.1×SSC at 45 degrees C., and a final rinse in pure water for 30 seconds.

8. Let the chip air dry for 10 minutes and then replace plastic cover onto chip. Place the sense chip into a testing machine and read the resistance and/or conductance levels of each sense site.

The sense chip is now ready for Hybridization

1. An improved apparatus for substrate cleansing comprising:
a planar substrate having a top side; and
means to scrub clean the planar substrate top side.

2. The apparatus of claim 1, wherein means to scrub clean the planar substrate top side further comprises:
at least one bead of predetermined diameter moving on and striking the substrate top side; and
means for movement of each bead onto the substrate top side.
c. The apparatus of claim 2, wherein bead composition is selected from the group consisting of: metal, coated metal, magnetic material, coated magnetic material, positively charged agarose material, negatively charged agarose material, coated positively charged agarose material, coated negatively charged agarose material, positively charged latex material, negatively charged latex material, coated positively charged latex material, coated negatively charged latex material, glass, coated glass, resin, coated resin, ceramic, coated ceramic, plastic, negatively charged plastic, positively charged plastic, coated plastic, negatively charged coated plastic, or positively charged coated plastic.

4. The apparatus of claim 2, wherein means for movement of each bead on the substrate top side further comprises at least one movement means selected from the group consisting of: substrate motion, external permanent magnets, external electromagnets, means for creating a varying external magnetic field, means for creating a vortex liquid, means for suspending beads in a solution and means for pressurized pumping of the suspended bead solution against the substrate top side.

5. The apparatus of claim 4 wherein the solution comprises at least one medium selected from the group consisting of: aqueous, air, and inert gas.

6. The apparatus of claim 4 wherein the substrate and solution are contained within a closed vessel.

7. An improved apparatus for isolation of unreacted bioreactive material and substrate cleansing comprising:
a planar semiconductor substrate having a top side;
a plurality of sense sites formed within the substrate top side further defining a matrix of sense sites, wherein each sense site comprises a well to receive probe molecules;
means to mechanically apply or synthetically construct a probe spot sample to a region of sense sites;
means to separate the probe spot sample into multiple, separate sense site wells; and
means to scrub clean the planar semiconductor substrate top side.

8. The apparatus of claim 7, wherein means to scrub clean the planar semiconductor substrate top side and means to separate the spot sample into multiple, separate sense site wells further comprise at least one bead of sufficient diameter moving on or contacting the substrate top side so that no bead can enter or drop down into the sense site wells, and means for movement or contact of each bead on the substrate top side.

9. The apparatus of claim 8, wherein bead composition is selected from the group consisting of: metal, coated metal, magnetic material, coated magnetic material, positively charged agarose material, negatively charged agarose material, coated positively charged agarose material, coated negatively charged agarose material, positively charged latex material, negatively charged latex material, coated positively charged latex material, coated negatively charged latex material, glass, coated glass, resin, coated resin, ceramic, coated ceramic, plastic, negatively charged plastic, positively charged plastic, coated plastic, negatively charged coated plastic, or positively charged coated plastic.

10. The apparatus of claim 9, wherein means for movement of each bead on the substrate top side further comprises at least one means for movement selected from the group consisting of: substrate motion, external permanent magnets, external electromagnets, means for creating a varying external magnetic field, means for creating a vortex liquid, means for suspending beads in a solution and means for pressurized pumping of the suspended bead solution against the substrate top side.

11. The apparatus of claim 10, wherein bead diameter ranges from 5 microns to 1000 microns.

12. The apparatus of claim 10, wherein bead diameter exceeds 1000 microns.

13. The apparatus of claim 10, wherein bead diameter is less than 5 microns.

14. The apparatus of claim 10 wherein the solution comprises at least one medium selected from the group consisting of: aqueous, air, and inert gas.

15. The apparatus of claim 14 wherein the substrate and solution are contained within a closed vessel.

16. A method for isolation of unreacted bioreactive material and substrate cleansing, the method comprising the steps of:
a. denaturing probe spot DNA by heating to 95 degrees C. for 15 minutes;
b. applying all probe spots to the array surface and drying;
c. coating the array surface with salmon sperm solution;
d. allowing the coated array surface to stand for a predetermined period of time;
e. applying means to link the probe molecules to the array surface;
f. rinsing the coated array surface with 2×SSC;
g. preparing a bead solution comprising 2×SSC or histidine and latex coated beads;
h. providing means to contain the bead solution;
i. providing means for bead movement;
j. placing the contained bead solution in working proximity with means for bead movement;
k. submerging the substrate top surface in the bead solution;
l. initiating means for bead movement;
m. allowing the substrate to be treated within the contained bead solution while means for bead movement is actively engaged for a predetermined period of time;
n. immediately rinsing the substrate top surface with 2×SSC twice at room temperature for a predetermined period of time for each wash;
o. allowing the substrate top side to dry while being stored in a covered environment;
p. taking baseline electrical measurements; and
q. covering and storing the substrate until ready for hybridization.

17. The method of claim 30, wherein a step of blocking and fixing stationary DNA to the sense chip further comprises the steps of:
a. to a clean 1.5 ml tube, adding 25 μL of Master mix (0.1 g dextran sulfate, 5 mL formamide, and 1 ml 20×SSC and water up to 7 ml, pH 7.0) and enough fractionated Salmon Sperm DNA to reach a concentration of 250 μg/ml;
b. heating the mixture to 37 degrees centigrade and quickly applying it to the surface of the sense chip, covering the sense chip cavity with a supplied plastic cover, and placing the sense chip on a slow rocker platform in 37 degrees centigrade incubator for 30 minutes;
c. rinsing the sense chip twice with 2×SSC solution at 45 degrees centigrade for 2 minutes, followed by 0.1×SSC and pure water for 2 minutes each;
d. applying means to link the probe molecules to the array surface;
e. in a separate container, combining beads with 2×SSC or histidine;
f. placing the bead based solution in working proximity to with means for bead movement;
g. securing the sense chip on means for bead movement;
h. activating means for bead movement;
i. treating the microarray for 2 minutes;
j. removing the sense chip from the base and quickly rinsing the sense chip in 2×SSC at 45 degrees centigrade for 2 minutes;
k. rinsing the sense chip for 2 minutes in 0.1×SSC at 45 degrees centigrade, and a final time in pure water for 30 seconds;
l. allowing the sense chip to air dry for 10 minutes and, if desired, replacing plastic cover onto the sense chip; and
m. placing the sense chip into a testing machine and reading the resistance and/or conductance levels of each sense site.
